(19) United States
(12) Patent Application Publication
(10) Pub. No.: US 2021/0259056 A1
(43) Pub. Date: Aug. 19, 2021

(54) SELF-REGULATING THERMAL TARGET

(71) Applicant: Caliente LLC, Fort Wayne, IN (US)

(72) Inventors: James T. Blake, Wolcottville, IN (US); Tyler W. Ambriole, Fort Wayne, IN (US)

(73) Assignee: Caliente LLC, Fort Wayne, IN (US)

(21) Appl. No.: 17/177,389

(22) Filed: Feb. 17, 2021

Related U.S. Application Data
(60) Provisional application No. 62/977,955, filed on Feb. 18, 2020.

(51) Int. Cl. H05B 3/20; H05B 3/12

(52) U.S. Cl. CPC H05B 3/20; H05B 3/12; H05B 2203/032; H05B 2203/02; H05B 2203/013

(57) ABSTRACT

A thermal target including a substrate and a positive temperature coefficient heater. The positive temperature coefficient heater includes at least one pattern of conductive ink printed on the substrate. The positive temperature coefficient heater is configured to provide at least one thermal signature. The positive temperature coefficient heater includes at least one Thermal Coefficient of Resistance (TCR) profile which increases at a set temperature to maintain the at least one thermal signature.

### CROSS REFERENCE TO RELATED APPLICATIONS

This is a non-provisional application based upon U.S. provisional patent application Ser. No. 62/977,955, entitled “SELF REGULATING THERMAL TARGET”, filed Feb. 18, 2020, which is incorporated herein by reference.

### BACKGROUND OF THE INVENTION

### 1. Field of the Invention

The present invention relates to thermal targets, and more particularly, to an active thermal target.

### 2. Description of the Related Art

Thermal targets can be in the form of active, electrically powered targets or passive targets which are not electrically powered. An active thermal target typically utilizes a “fixed” resistance heating system. A fixed resistance heating system generally includes a power source, e.g. a battery, and an electrical circuit that heats up via an electrical current flowing through the target in order to produce a thermal image. The electrical circuit includes a conductive material with a “negligible” resistance shift over temperature, for instance a Thermal Coefficient of Resistance (TCR) which is typically in the range of 1˜5%/ppm/° C.

Thermal targets with fixed resistance heating systems have several pitfalls. One well documented issue with such thermal targets, especially those simulating a human body, is that they don't provide a realistic human heat signature. Generally, the thermal signature is significantly hotter than an actual human signature. Such thermal targets may also experience thermal runaway, which may result in significant damage to the target itself or the objects or personnel near the target. As a result of the potential for thermal runaway often times expensive circuit protection measures have to be taken in order to attempt to mitigate this risk. These preventative measures have had mixed results given the various electrical systems and configurations at a given installation and are a significant added expense. Furthermore, such fixed resistance targets may be energy inefficient. Fixed resistance heating systems draw relatively the same amount of power regardless of the temperature of the target. This constant energy consumption, regardless of the targets temperature, results in energy usage which is a strain on the power system for the thermal target. This is a significant issue where batteries are used to energize thermal targets as the training hours are already limited by power available in the battery. The constant power draw from the fixed resistance targets results in precious energy and training hours being lost powering a target that in many situations already provides an unrealistic thermal signature.

Historically, the approach to overcoming the issue of providing an unrealistic thermal heat signature has been to vary the watt density. For example, U.S. Patent Application Pub. No. 2009/0194942 A1 describes varying the footprint of a thermal target to alter the watt density therein.

What is needed in the art is an energy efficient thermal target which more accurately represents a thermal signature of a given subject.

### SUMMARY OF THE INVENTION

The present invention provides a self-regulating thermal target. The target includes a substrate and a positive temperature coefficient heater. The positive temperature coefficient heater includes at least one pattern of conductive ink printed on the substrate. The positive temperature coefficient heater is configured to provide at least one thermal signature. The positive temperature coefficient heater includes at least one Thermal Coefficient of Resistance (TCR) profile which significantly increases at a set temperature to maintain the at least one thermal signature. Therein, the positive temperature coefficient heater self-regulates the amount of current it draws from the power source.

The invention in one form is directed to a thermal target including a substrate and a positive temperature coefficient heater. The positive temperature coefficient heater includes at least one pattern of conductive ink printed on the substrate. The positive temperature coefficient heater is configured to provide at least one thermal signature. The positive temperature coefficient heater includes at least one Thermal Coefficient of Resistance (TCR) profile which increases at a set temperature to maintain the at least one thermal signature.

The invention in another form is directed to a method for producing a thermal target. The method includes an initial step of providing a substrate and a positive temperature coefficient heater. The positive temperature coefficient heater includes conductive ink and at least one Thermal Coefficient of Resistance (TCR) profile. The positive temperature coefficient heater is configured to provide at least one thermal signature. The method further includes selecting a set temperature. The method further includes printing at least one pattern of the conductive ink on the substrate, wherein the at least one TCR profile is configured to increase at the set temperature to maintain the at least one thermal signature.

An advantage of the present invention is that, due to the TCR profile of the conductive ink, the thermal target self-regulates the amount of current which it draws from the power source.

Another advantage of the present invention is that the thermal target is energy efficient since it only draws the requisite amount of current from the power source.

Yet another advantage of the present invention is that the thermal target accurately simulates a thermal signature of a given subject without experiencing thermal runaway.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 illustrates a prior art heating system with a negligible Thermal Coefficient of Resistance (TCR) ranging between 1 and 1.05 as the temperature of the target increases from 0 to 100° C.;

FIG. 2 illustrates an embodiment of a thermal target which utilizes a Positive Temperature Coefficient (PTC) heater in the form of ink traces which are applied to a substrate;

FIG. 3 illustrates a schematic view of a portion of the pattern of ink traces in the thermal target of FIG. 2;

FIG. 4 is a graphical illustration of the TCR properties of a thermal target according to the invention as the temperature of the target increases;

FIG. 5 is another graphical illustration of the TCR properties of another thermal target according to the invention as the temperature of the target increases;

illustrates another embodiment of

FIG. 6 illustrates a schematic view of another embodiment of a thermal target, wherein the thermal target includes two separate patterns of ink traces; and

FIG. 7 illustrates another embodiment of a thermal target, as viewed through a thermal imaging device, wherein the thermal target is in the shape of a vehicle.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

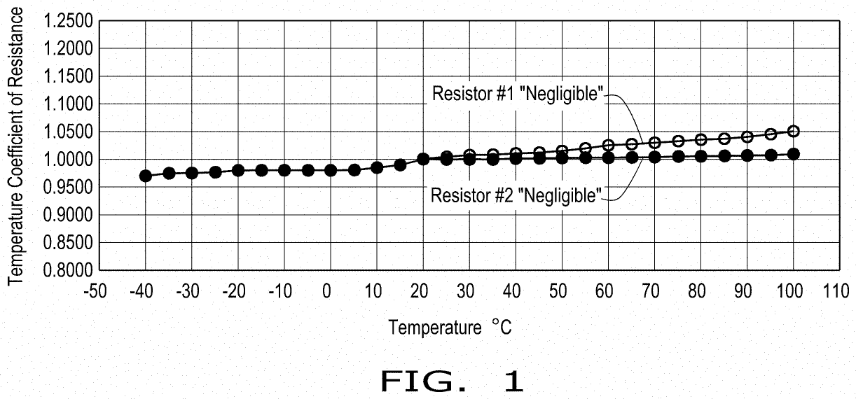

Referring now to the drawings, and more particularly to FIG. 1, there is shown a graphical illustration of the Thermal Coefficient of Resistance (TCR) of a typical prior art target. Current thermal targets have utilized a well-established “fixed” resistance heating system. Fixed resistance heating systems are generally characterized as having a conductive material with a negligible resistance shift over temperature. FIG. 1 illustrates such a fixed heating system with a negligible TCR ranging between 1 and 1.05%/ppm/° C. as the temperature of the target increases from 0 to 100° C. Due to the relatively constant TCR, the thermal target may experience a thermal runaway wherein the temperature of the target becomes increasingly hotter. Furthermore, such a fixed resistance heating system may not accurately represent the thermal signature of a given subject due its TCR properties.

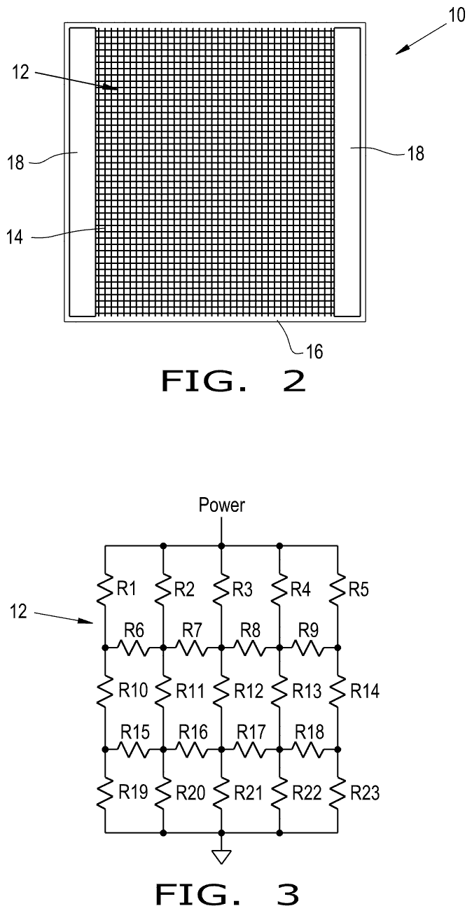

Referring now to FIGS. 2-3, there is shown an embodiment of a thermal target 10 which utilizes a Positive Temperature Coefficient (PTC) heater 12 with variable TCR properties. The PTC heater 12 comprises conductive ink traces 14 which are printed onto a substrate 16. The PTC heater 12 has at least one TCR profile that significantly increases at a respective set temperature in order to maintain a desired temperature (which may or may not be the same as the set temperature) for simulating the desired thermal signature(s) of the target 10.

The target 10 may be coupled to one or more power sources, such as one or more batteries, for supplying an electrical current to the PTC heater 12. In this regard, the PTC heater 12 is operably coupled with the power source and may accordingly self-regulate the amount of current which it draws from the power source. The target 10 may also include two parallel buss bars 18 coupled to the horizontal ink traces 14. The target 10 may further include one or more overlay materials. The target 10 may also include a foam layer and/or covering to help reduce thermal loss. For instance, a thin film polyethylene foam padding can be bonded to the back of the target 10. Additionally, for instance, a cover may encase the substrate 16 and PTC heater 12 printed thereon. As can be appreciated, the target 10 may comprise any desired shape and size.

Referring now specifically to FIG. 3, there is shown a schematic representation of a portion of the pattern of the PTC heater 12. As is generally known, the conductive ink traces function as a grid of resistors, which in turn provide a desired thermal signature. As shown, the ink traces 14 are printed onto the substrate 16 in a single grid pattern with horizontal and perpendicular vertical lines. However, it should be appreciated that the PTC heater 12 may have any desired pattern, including a diagonal pattern, circular pattern, etc. Additionally, it should be appreciated that the ink traces 14 themselves may comprise any desired shape and size which may or may not correspond to one another. Furthermore, the pattern(s) of ink traces 14 may have any desired distance or spacing between adjacent ink traces 14. For instance, for a high watt density, the ink traces 14 may be located close to one another in a dense pattern. Additionally, for instance, for a low watt density, the ink traces 14 may be spaced further apart from one another to create a less dense pattern.

The PTC heater 12 may simulate any desired thermal heat signature(s) of one or more subjects within a given target 10. The ink traces 14 of the PTC heater 12 may all be made of the same material. Therein, all of the ink traces 14 may provide the same thermal signature. Alternatively, the ink traces 14, or portions thereof within a single line, may comprise differing materials. Therein, a single pattern of ink traces 14 may provide one or more differing thermal signatures. For example, the target 10 may simulate a human body with differing thermal signatures at certain portions of the body. Additionally, for example, the target 10 may simulate a human body with a single thermal signature which is limited to 40° C. Additionally, the target 10 may simulate a tank turret with a single thermal signature which is limited to 60° C.

The PTC heater 12 may have a preset TCR which significantly increases at a set temperature or within a temperature range. As used herein, the term “set temperature” may refer to a desired temperature that is chosen by a user at which the TCR begins to increase in order to reduce the amount of current which flows through the conductive ink traces 14. As used herein, the term “significantly increases” may refer to a TCR that increases at such an amount to maintain a desired thermal signature. It should be appreciated that the supply of current from the power source may or may not remain the same as the TCR significantly increases. Thereby, the increase in the TCR of the heater 12 is not negligible as is the TCR of the target of FIG. 1. For instance, the TCR of the PTC heater 12 may increase by at least a factor of two, for instance five or ten, at a given preset temperature.

The TCR properties of a given PTC heater 12 may be adjusted as desired by altering the ink composition. For instance, the ink may be adjusted by increasing or decreasing the amount of one or more compounds, e.g. silver, which is present in the ink. The ink printer may automatically adjust the composition of the ink. Therein, one or more differing patterns of ink traces may be printed on the substrate 16. Furthermore, one or more ink traces 14, or portions thereof, within a single pattern may be accordingly adjusted to provide multiple differing thermal signatures within the pattern. Thus, via the TCR profile(s), the PTC heater 12 acts as a self-regulating heater to vary the amount of current it draws from the power source to maintain the desired thermal signature(s). Hence, due to the self-regulating functionality of the PTC heater 12, the PTC heater 12 may accurately simulate a thermal signature of a given subject without experiencing a thermal runaway. As used herein, “accurately simulate” may refer to representing a desired thermal signature within a range of plus or minus 2° C.

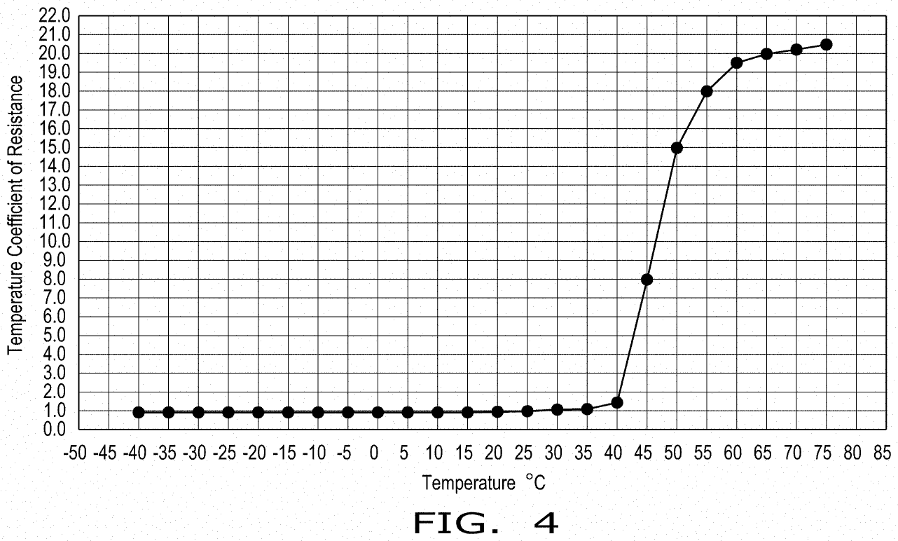

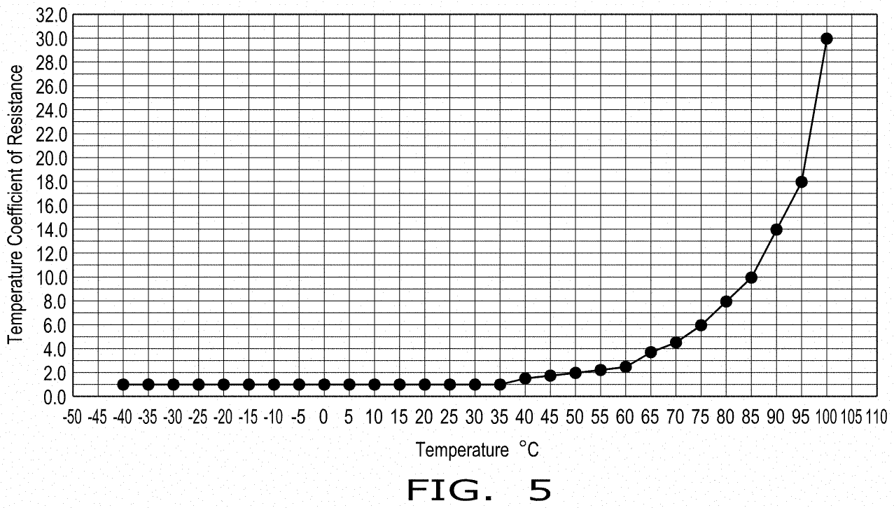

Referring now to FIGS. 4-5, there are shown graphical representations of the TCR profiles, i.e., resistance properties, of respective thermal targets 10 which each include the PTC heater 12 according to the invention. In both FIGS. 4 and 5, the TCR profile is exponential such that the TCR significantly increases as the temperature increases. FIG. 4 illustrates an embodiment of a PTC heater 12 in which the TCR nearly instantaneously increases at a set temperature. In FIG. 4, the TCR of the heater 12 remains substantially unchanged until the temperature of the target 10 reaches about 35° C., at which point the TCR begins to noticeably increase. Then at about 40° C. the TCR increases significantly, and begins to plateau out again at around 60° C. FIG. 5 illustrates another embodiment of a PTC heater 12 that remains substantially unchanged until the temperature of the target 10 reaches about 35° C., at which point the TCR begins to noticeably increase. The TCR increases somewhat exponentially at the target temperatures, ranging between 35 C to 100 C.

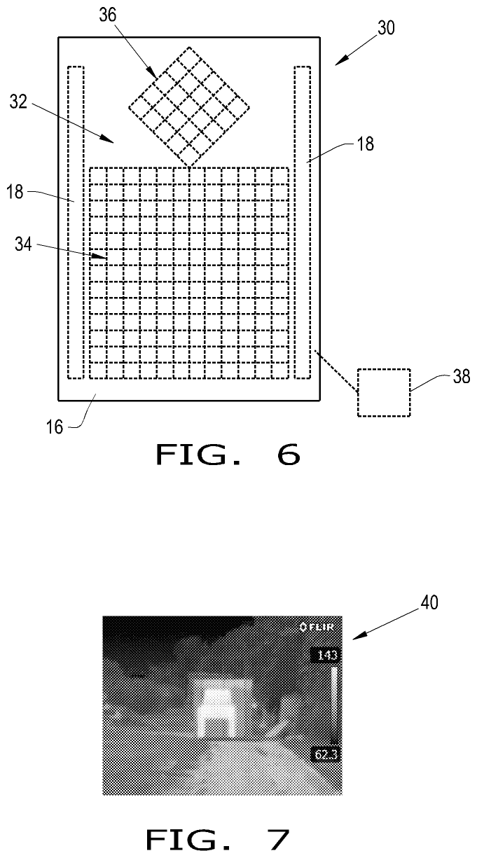

Referring now to FIG. 6, there is shown another embodiment of a thermal target 30. The thermal target 30 may be substantially the same as the thermal target 10 discussed above, except that the thermal target 30 includes a PTC heater 32 with two or more patterns of ink traces 34, 36 that are printed onto the substrate 16. The thermal target 30 may be coupled to one or more power sources 38. Like elements have been identified with like reference characters throughout the several view.

The patterns of ink traces 34, 36 may or may not differ from one another. For example, the patterns of ink traces 34, 36 may comprise differing shapes, number of ink traces, and/or compositions which provide differing TCR profiles. Therein, the thermal target 30 may provide multiple TCR profiles for accurately simulating multiple thermal signatures without experiencing thermal runaway.

Referring now to FIG. 7, there is shown another embodiment of a thermal target 40, as viewed through a thermal imaging device. The thermal target 40 may be substantially the same as the thermal target 10 or thermal target 30 discussed above, except that the thermal target 40 is in the shape of a vehicle.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A thermal target, comprising:
a substrate; and
a positive temperature coefficient heater comprising at least one pattern of conductive ink printed on the substrate, the positive temperature coefficient heater being configured to provide at least one thermal signature, the positive temperature coefficient heater comprising at least one Thermal Coefficient of Resistance (TCR) profile which increases at a set temperature to maintain the at least one thermal signature.

2. The thermal target of claim 1, wherein the positive temperature coefficient heater is configured to accurately simulate the at least one thermal signature of a given subject without experiencing thermal runaway.

3. The thermal target of claim 1, wherein the positive temperature coefficient heater is configured to couple with and receive an amount of current from a power source, wherein the positive temperature coefficient heater is configured to self-regulate the amount of current.

4. The thermal target of claim 1, wherein the at least one TCR profile increases by a factor of two at the set temperature.

5. The thermal target of claim 1, wherein the at least one TCR profile is exponential.

6. The thermal target of claim 1, wherein the positive temperature coefficient heater comprises two or more differing TCR profiles, wherein each TCR profile increases at a respective set temperature to maintain a respective thermal signature.

7. The thermal target of claim 1, wherein the positive temperature coefficient heater comprises a first pattern of conductive ink and a second pattern of conductive ink which differs from the first pattern of conductive ink.

8. A method for producing a thermal target, comprising:
providing a substrate and a positive temperature coefficient heater comprising conductive ink and at least one Thermal Coefficient of Resistance (TCR) profile, the positive temperature coefficient heater being configured to provide at least one thermal signature;
selecting a set temperature; and
printing at least one pattern of the conductive ink on the substrate,
wherein the at least one TCR profile is configured to increase at the set temperature to maintain the at least one thermal signature.

9. The method of claim 8, further comprising adjusting an ink composition of the conductive ink to adjust the TCR profile.

10. The method of claim 8, wherein the positive temperature coefficient heater is configured to accurately simulate the at least one thermal signature of a given subject without experiencing thermal runaway.

11. The method of claim 8, wherein the positive temperature coefficient heater is configured to couple with and receive an amount of current from a power source, wherein the positive temperature coefficient heater is configured to self-regulate the amount of current.

12. The method of claim 8, wherein the at least one TCR profile increases by a factor of two at the set temperature.

13. The method of claim 8, wherein the at least one TCR profile is exponential.

14. The method of claim 8, wherein the positive temperature coefficient heater comprises two or more differing TCR profiles, wherein each TCR profile increases at a respective set temperature to maintain a respective thermal signature.

15. The method of claim 8, wherein printing the at least one pattern of the conductive ink on the substrate comprises printing a first pattern and a second pattern which differs from the first pattern.
